(19) United States
(12) Patent Application Publication
(10) Pub. No.: US 2003/0082969 A1
(43) Pub. Date: May 1, 2003

(54) Breathable barrier extruded laminate

(76) Inventor: Trevor Arthurs, Truro (CA)

Correspondence Address: Roberts Abokhair & Mardula, LLC, Suite 1000, 11800 Sunrise Valley Drive, Reston, VA, 20191, US

(21) Appl. No.: 10/280,526

(22) Filed: Oct. 25, 2002

Related U.S. Application Data
(60) Provisional application No. 60/336,281, filed on Oct. 25, 2001.

(51) Int. Cl. B32B 5/18; B32B 5/22; B32B 3/10

(52) U.S. Cl. 442/76; 442/286; 442/290; 428/131; 442/131; 442/149

(57) ABSTRACT

A breathable laminate produced without the use of a needle punch has been disclosed comprising a breathable film, a tie layer bonding material and a flexible woven substrate. The breathable film is one of commercially available breathable films, for example an apertured polyolefin film, that has a high moisture vapor transmission rate (MVTR). The woven substrate provides strength and flexibility, and in preferred embodiments is woven from polyolefin tapes. The tie layer bonding material comprises a polyolefin material that is non-breathable but formed into a porous discontinuous web by the methods and processes disclosed herein. The three layers are joined through a laminating process.

### CROSS REFERENCE TO RELATED APPLICATIONS

This application claims priority from pending U.S. provisional patent application serial No. 60/336,281, filed Oct. 25, 2001.

### BACKGROUND

The present invention relates to extruded laminated fabrics having high moisture vapor transmission rate (MVTR).

Composite fabrics or films are used to provide a barrier to infiltration from the elements yet allow moisture vapor transmission to external air. The MVTR is indicia of breathability. These highly oriented materials are used to allow moisture to escape from an object yet protecting the object from air, water and particulate infiltration. Often used for home construction to protect walls and roofs, the product is referred to as a housewrap. Other applications apply these breathable barriers to clothing and disposable diapers.

Housewrap breathable films, such as porous polyolefin films, are attached or secured outside of the sheathing in the walls of homes, especially in cold climates. On the one hand, housewrap materials must be permeable to water vapor to allow water vapor to escape from the wall to which the film is secured. Otherwise, water trapped in the wall may cause a condition known as “sweating” or rotting which may ultimately damage the wall. On the other hand, the housewrap must be sufficiently impermeable to air to insulate the wall against wind, water and dust. Further, the film must have adequate tensile and physical properties such as break strength, elongation, tear strength, shrinkage and puncture strength to avoid damage during installation and to facilitate durability.

One commercially available film used as a housewrap is made of high density polyethylene (HDPE) flash spun into fibers and pressed to form the film. The resulting flash-spun HDPE film has an excellent MVTR, but suffers from both high air permeability and relatively low tear strength. Thus, such housewrap is subject to damage during shipment and installation.

Another commercially available film employed as a housewrap is melt blown, spun-bonded polyethylene. Like the flash-spun HDPE fiber film, the spun-bonded polyethylene has excellent breathability, but likewise has a high permeability to air and even worse tensile properties, i.e. break strength, tear strength and puncture resistance. Thus, there is an unfilled need for a housewrap film with both high MVTR and good physical and tensile properties.

Many such housewraps have poor dimensional stability, and tend to sag over time causing tears, thus allowing air infiltration. To avoid such sagging, reinforcement filaments are sometimes incorporated into the housewrap products. However, many of these commercially available products containing reinforcement filaments tend to fail due to separation of the woven structures from the laminate.

Many of the strength deficiencies could be overcome by use of a polyolefin woven substrate. Woven substrates are capable of many times the bursting strength of commercially available housewraps. When attached using staples, and the like, woven substrates are also much more resistant to staple pull-throughs.

It would be desirable to prepare a house wrap laminate containing a woven substrate that is securely bonded to the breathable film. Further, it would be desirable to prepare a coated substrate wherein the resultant laminate would retain its structural integrity while maintaining a barrier to air and water but allowing the moisture vapor to pass through.

U.S. Pat. Nos. 5,554,246 and 5,773,123 to Anwyll, Jr. disclose a process for preparing an air infiltration barrier comprising a woven substrate. The process comprises supplying a woven polyolefin fabric, supplying a polyolefin film, coating the polyolefin fabric with an extruded molten resin, laminating the film and fabric and perforating the laminate using a mechanical punch. The resin provides strong bonding capability and the woven fabric provides strength and flexibility.

A needle punch used to perforate the laminate structure penetrates multiple layers of the laminate and requires a mechanical step of perforating the laminate. It would be desirable to have a process where the mechanical step of perforating is eliminated, and, further, where the perforations or discontinuities are limited to the bonding material within the laminate. Further, current building codes and current market find a barrier laminate with mechanically produced holes unacceptable.

Sheth discloses in U.S. Pat. No. 4,929,303 a composite breathable laminate a breathable polyolefin film to a non-woven substrate by applying a stretching and heating process. The combined process causes small discontinuities in the laminate allowing vapor to be released and still have an effective barrier to air and moisture. While the Sheth patent overcomes the deficiencies of a mechanical perforator, other short comings are introduced.

Lamination of thin breathable films to one or more supporting layers in a manner to achieve the desired peel strength is particularly difficult without degrading either the barrier properties and/or the breathability of the films. Generally speaking, when thermally bonding two layers of thermoplastic materials together, better lamination or peel strengths may be achieved by increasing the bonding temperature and/or by increasing the overall bond area. Thermal bonding of thin films and a support layer at temperatures necessary to achieve increased peel strengths often create “burn throughs” or pinholes in the film which degrade the barrier properties.

Extensive thermal bonding can also undesirably decrease the flexibility of the resulting laminate. Moreover, adhesive lamination of the thin breathable film and support fabric may often likewise suffer from de-lamination as a result of the physical and mechanical stress experienced by breathable barrier laminates. Furthermore, certain adhesives can decrease the breathability of the laminate and/or undesirably stiffen the laminate.

Haffner et al. disclose in U.S. Pat. No. 6,045,900 co-extruded micro-porous films that use non-heat laminated bonding techniques to a non-woven substrate fabric. This avoids undesirable features of heat laminating. However, multiple porous films are used at some additional expense. It would be desirable to maintain peel resistance, breathability, strength and flexibility without requiring multiple breathing films. Additionally, the non-woven substrate provides inferior burst and tear strengths.

What is desirable is a laminated, breathable barrier material that provides high MVTR, strict orientation (i.e., allows vapor to escape but is impervious to air infiltration), high flexibility, superior strength, structural integrity, ease of production and low cost.

### SUMMARY OF THE INVENTION

It is an objective of the present invention to provide a high MVTR barrier material that is highly resistant to air, water and particulate matter infiltration.

It is another objective of the present invention to provide a barrier material that is strong, having improved tear and tensile strength. It is still a further objective of the present invention to provide a barrier material that is flexible yet resists permanent deformation.

It is yet another objective of the present invention to provide a barrier material that resists laminate peeling.

It is still another objective of the present invention to provide a barrier material that is economical and relatively simple to produce.

One embodiment of the present invention is a breathable extruded barrier laminate having three layers. The bottom layer is a woven polyolefin substrate or a double stacked weave polyolefin substrate. The middle tie layer is polyolefin applied in a porous web and provides adhesive bonding between the bottom and top layers. The tie layer bonding material is made from a polyolefin material that is non-breathable. A top breathable film is laminated to the middle tie layer. The top breathable film may comprise a commercially available apertured polyolefin film having high moisture vapor transmission rate.

In certain embodiments of the invention, the middle tie layer comprises a polyolefin and a foaming agent applied in a porous web. Foaming agents may comprise 1% to 5% by weight of the tie layer. Useful foaming agents include, for example, citric acid and azodicarbonimide.

In other embodiments of the invention, the middle tie layer comprises a polyolefin and an incompatible polymer, applied in a porous web. Incompatible polymers may comprise 1% to 30% by weight of the tie layer.

In some embodiments of the present invention, the woven substrate is made from polyolefin tapes that are woven. In one embodiment the polyolefin tapes comprise high density polyethylene (HDPE). The polyolefin tapes may also be woven into a double stacked weave.

### BRIEF DESCRIPTION OF THE DRAWINGS

FIG. 1 is a schematic representation of a plan view of insulation facing of the present invention;

FIG. 2A is a schematic representation of a cross section of the insulation of FIG. 1 through A-A using single stacked woven substrate;

FIG. 2B is a schematic representation of a cross section of the insulation of FIG. 1 through A-A using single stacked woven substrate;

FIG. 3A is a schematic representation of a cross section of the insulation of FIG. 1 through A-A using double stacked woven substrate; and

FIG. 3B is a schematic representation of a cross section of the insulation of FIG. 1 through A-A using double stacked woven substrate.

### DETAILED DESCRIPTION OF THE INVENTION

The present invention is a laminate of a breathable film, tie layer bonding material and a flexible woven substrate. The breathable film is one of commercially available breathable films, for example an apertured polyolefin film, that has a high moisture vapor transmission rate (MVTR). The substrate provides strength and flexibility, and in preferred embodiments is woven from polyolefin tapes. The tie layer bonding material comprises a polyolefin material that is non-breathable but formed into a porous discontinuous web by the methods and processes disclosed herein. The three layers are joined through a laminating process.

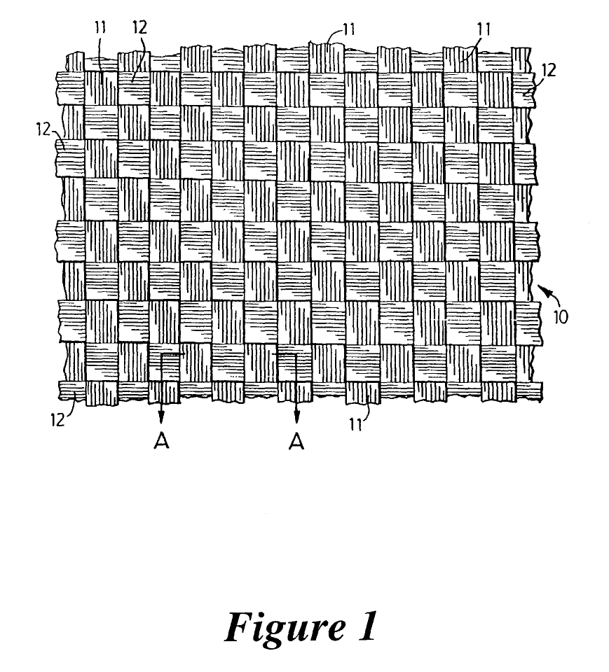

FIG. 1 illustrates a plan view of the present invention, generally indicated as 10. Breathable laminate 10 has a plurality of warp tapes, indicated by 11, interwoven with a plurality of weft tapes, indicated by 12 that are laminated to breathable film. The warp tapes 11 are in a side-by-side relationship with each other and similarly, the weft tapes are in a side-by-side relationship. Moreover, the warp tapes are in a substantially parallel relationship with each other, and similarly the weft tapes are in a substantially parallel relationship. Woven substrates of the breathable laminate generally as illustrated in FIG. 1 are known, as are methods for the manufacture of such woven substrates.

As used herein “polyolefin” refers to polymeric materials such as polyethylene, polypropylene in homopolymers as well as copolymers and terpolymers. Particularly preferred polyolefins are polypropylene and polyethylene homopolymers. Polypropylene is available as a homopolymer, random copolymer, impact copolymer or block copolymer. Examples of the flexible substrate of this invention used to prove the viability of the present invention were made from homopolymer. They could also be made from impact copolymer or block copolymer.

As used herein polyolefin tapes refers to tapes used in the fabrication of woven substrates as are known in the art. They are typically formed by slitting of a sheet film of polyolefin. Other tapes may be profiled or fibrillated tapes, including tapes with flat, round or oval cross-sections. Examples of the latter tapes include extruded monofilament tapes.

Examples of polyolefins suitable in the manufacture of the woven substrate include those comprising in large part high density polyethylene (HDPE) or polypropylene. The HDPE or polypropylene may be any slit tape grade HDPE or polypropylene. Typically slit tape grade HDPE will have a melt flow index in the range between 0.2 and 5.0. For example, a slit tape grade HDPE may have a melt flow index of 0.6. Typically a slit tape grade polypropylene will have a melt flow rate in the range of 1.0 and 20.0. For example, a slit tape grade polypropylene may have a melt flow rate of 3.0. Slit tape grade HDPE and polypropylene are available from such companies as Nova Chemicals, Dow Chemical and Huntsman Chemicals.

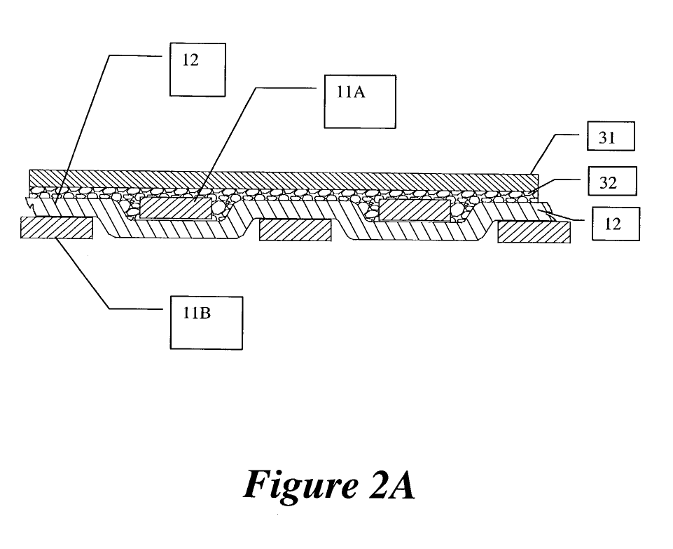

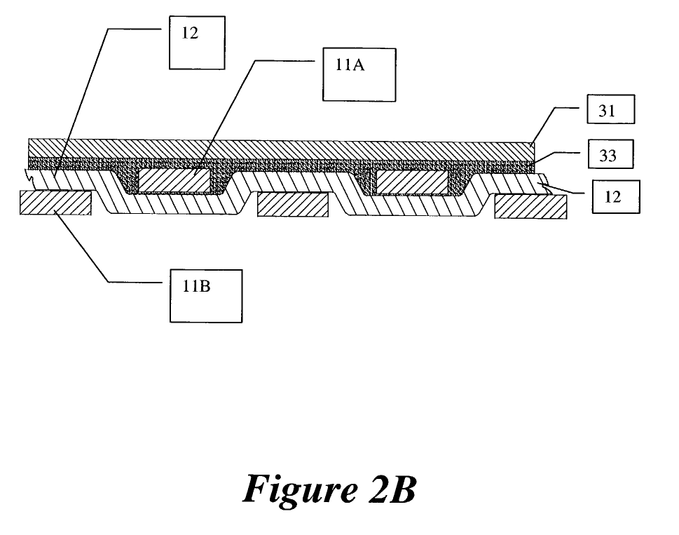

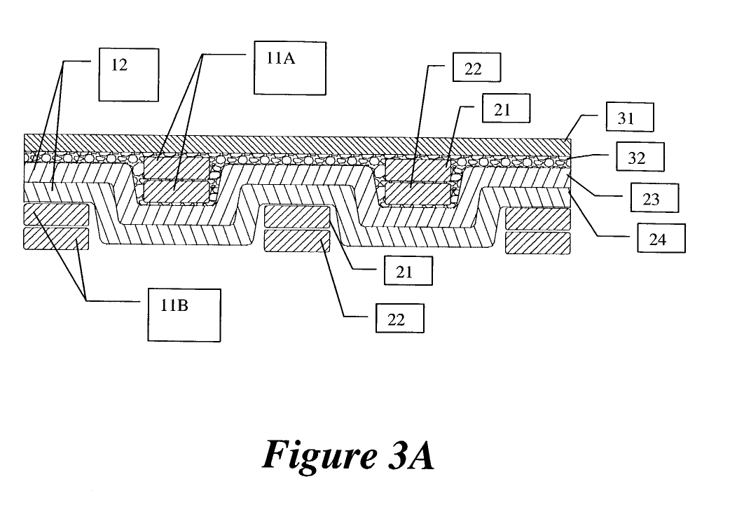

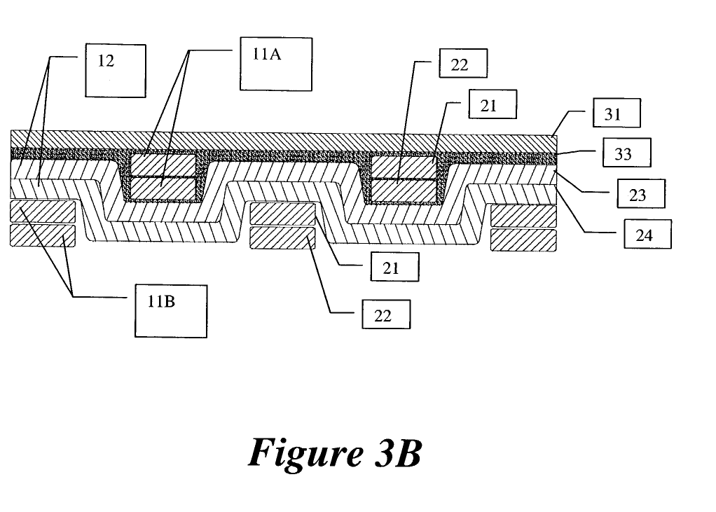

FIG. 2A and FIG. 2B illustrate a cross section of the breathable laminate of the present invention utilizing a single layer of polyolefin tapes in the woven substrate. The flexible woven substrate may also provide for additional tear strength by being woven of two tapes, superimposed one upon the other, as is illustrated in FIG. 3A and FIG. 3B. The multiple superimposed tapes can be provided in either the warp or weft direction, but preferably in both directions. For example, when 2 superimposed tapes are woven in both directions, the flexible woven substrate is known as a double stacked weave or a 2×2 weave. U.S. Pat. No. 6,367,513 to Cain discloses methods of manufacturing double stacked weave flexible substrates and is incorporated by reference.

The present invention is not apparent in FIG. 1 as illustrated but is particularly illustrated in the cross section of the breathable laminate shown in FIG. 2A, FIG. 2B, FIG. 3A and FIG. 3B, which depict a cross section of FIG. 1 through A-A. In the embodiments illustrated, the warp tapes are generally indicated by 11A or 11B and the weft tapes as 12. Warp tapes 11A are those sections of the superimposed warp tapes appearing on the upper side of the substrate whereas warp tapes 11B are those sections of the tapes appearing on the under side of the substrate.

In FIG. 3A and FIG. 3B, two warp tapes are superimposed upon each other as, for example, tapes 21 and 22. Similarly, two weft tapes are superimposed on each other as, for example, 23 and 24.

There are two sides to the breathable laminate: a breathable film side and a woven substrate side. The breathable film 31 is on the outside of the breathable laminate and woven substrate layers is on the inside, as illustrated. Tie layer bonding material is illustrated as layer 32 or layer 33.

In FIG. 2A and FIG. 3A tie layer bonding material 32 comprises foamed polyolefin. In contrast, FIG. 2B and FIG. 3B comprise tie layer bonding material 33 that is formed of incompatible polyolefin blend.

The polyolefins of the present invention may further comprise compounds that prevent actinic radiation or ultraviolet (UV) light damage and degradation to the protective wrap. Useful compounds for this purpose include ultraviolet light absorbers and stabilizers. Other additional compounds may also be added to the polyolefins used in the present invention and include, for example, pigments and heat stabilizers.

Selection of tie layer bonding material must take into account the means employed to apply the tie layer bonding material to the flexible substrate. One convenient method is to extrusion coat the tie layer material onto the substrate. When using extrusion coating, a suitably high melt flow material must be selected for the tie layer bonding material to insure ease of extrusion and good adhesion to the flexible substrate. For most instances a melt flow index range of 2 to 50 or melt flow rate of 5 to 100 is adequate.

FIG. 2A and FIG. 3A illustrate the use of foaming tie layer 32. Foaming tie layer 32 comprises polyolefin of suitable melt flow rate and a foaming agent. The amount of foaming agent used depends upon the particular agent but typically comprises from 1% to 5% by weight of the tie layer. Foaming agents are known in the art and cause foaming of the polyolefin. Example foaming agents include citric acid and azodicarbonimide, although other agents may be used.

Foaming tie layer 32 of the present invention forms into a random discontinuous and porous web. It permits the physical migration of water vapor from the polyolefin substrate to the breathable polyolefin film. In one embodiment of the present invention the foaming tie layer comprises low density polyethylene with 1% to 5% foaming agents.

In place of a foaming agent, FIG. 2B and FIG. 3B illustrate the use of an incompatible polymer added to the tie layer 33. Incompatible polymers are selected so that the tie layer bonding material forms a grainy, discontinuous porous web. The amount of incompatible polymer used depends upon the particular polymer but typically comprises from 1% to 30% by weight of the tie layer bonding material. When used with a low density polyethylene tie layer material, incompatible polymers include polyamide, polyester, polystyrene, polycarbonate, polyvinyl chloride, and the like.

In one embodiment of the present invention, the laminate's surface film will have a MVTR of about 2000 gm/m²/24 h. The breathable oriented film may be selected from commercially available breathable film. An example is Tredegar Corporation breathable film Exaire BF519K2. Particularly preferred of the commercially breathable films are the apertured films.

In a preferred embodiment of the present invention, the substrate is woven from oriented HDPE tapes. The material, denier, spacing and orientation of the tapes determine the flexibility, stretch ability, structure stability, sheer strength, tensile strength and weight of the fabric. For example, . . . not limiting . . . The weave uses 7.5 tapes of 900 denier per inch in the warp and 4 tapes of 1200 denier per inch in the weft.

The breathable laminate of the present invention is produced by coating the woven substrate with the tie layer bonding material and then laminating breathable film 31 to the coated woven substrate. One convenient method of coating the tie layer bonding material to the woven substrate is to extrusion coat the tie layer bonding material onto the substrate. The type of polymer and thickness of tie layer 32 or 33 is selected to provide good adhesion between the substrate and the breathable film. In general, thicknesses of 0.2 to 3 mil are used. For example, a 1 mil average thickness of tie layer is often suitable. Low density polyethylene (LDPE) is often selected as the polymer type.

Lamination is completed by compressing the breathable film onto the coated woven substrate. Use of a pressure lamination process enhances the product's stability and anti-peeling properties compared to a heat lamination process. Heat lamination processes are subject to “burn throughs” or pinholes and may cause undesirable side effects to the substrate and surface film.

Anwyll, Jr. U.S. Pat. No. 5,554,246 is incorporated by reference in its entirety. U.S. Pat. No. 5,554,246 uses a needle punch in the process to mechanically perforate the laminate. The perforations create channels allowing moisture to traverse from the woven substrate, through the bonding layer (which is otherwise impervious to air and water) and then through the breathable film.

One improvement of the present invention is the elimination of the mechanical punch process, thus eliminating one critical point in the barrier production. Further, mechanical perforation processes are in disfavor because they tend to be less effective in maintaining imperviousness to air and water coming into the wrapped object.

### EXAMPLE

The following describes an example of producing a breathable laminate of the present invention. This example is described as illustrative only and should not be considered limiting to the invention.

This example comprises a bottom woven polyolefin substrate; a middle tie layer of polyolefin structured to contain porous channels, and a top breathable film adhered to the middle tie layer.

The breathable exterior barrier, in one embodiment of the present invention, is highly oriented polypropylene film. In another, embodiment the breathable film is an apertured film. Theses films are commercially available.

The middle tie layer, used in this example comprised an extruded, molten resin made from LDPE and a citric acid foaming agent (1.5% by weight). The foaming agent causes porous channels to be formed in this layer.

As noted above, alternative embodiments will use a small amount of one or more foaming agents or some polymer that is incompatible with LDPE (or other polyolefin substance used as the bonding agent).

The woven substrate layer, in this example, is a woven fabric made from high density polyethylene (HDPE) tapes. The woven fabric is unrolled from a supply roll. The molten resin is layered onto the substrate. For this example, the woven substrate comprises 7.5 tapes of 900 denier per inch in the warp direction and 4 tapes of 1200 denier per inch in the weft direction.

The breathable film is also unrolled from a supply roll. The film is layered on top of the exposed resin causing the film to adhere to the substrate forming a laminate. The laminate is drawn across a nip roll compressing the laminate layers thus reinforcing the bonding. Then the laminate is drawn over a chill roll to cool the laminate. The continuous laminate, in sheet form, is then collected on a take up roll.

A breathable laminate produced without the use of a needle punch has been disclosed. It will be readily apparent to those skilled in the art that other modifications and variations can be made without departing from the spirit or scope of the present invention. For example, the types of polymers used may be varied. Similarly, different foaming agents and combinations of agents may be used to create the porous channels in the tie layer bonding material. Other incompatible polymers may be selected for an incompatible polymer tie layer. As an application requires, different warp and weft tape or yarn spacing as well as deniers may be employed to achieve different substrate characteristics. The use of a double stacked woven substrate is also to be considered within the scope of the invention.

What is claimed is:

1. A breathable polyolefin laminate comprising:
(i) a breathable polyolefin film;
(ii) a tie layer bonding material; and
(ii) a flexible polyolefin woven substrate;
wherein the breathable polyolefin film comprises porous channels that permit high moisture vapor transmission with low air penetration and with high water penetration resistance;
wherein the tie layer bonding material adheres the breathable polyolefin film to the flexible polyolefin woven substrate;
wherein the tie layer bonding material comprises non-breathable polyolefin applied in a porous web; and
wherein the breathable polyolefin laminate provides high moisture vapor transmission with low air penetration and with high water penetration resistance without needle punching of the laminate.

2. The breathable polyolefin laminate of claim [c1] wherein the breathable polyolefin film comprises apertured polyolefin film.

3. The breathable polyolefin laminate of claim [c1] wherein the breathable polyolefin film further comprises ultraviolet light inhibitors.

4. The breathable polyolefin laminate of claim [c1] wherein the flexible polyolefin woven substrate comprises polyolefin selected from the group consisting of polypropylene and polyethylene.

5. The breathable polyolefin laminate of claim [c4] wherein the flexible polyolefin woven substrate comprises high density polyethylene.

6. The breathable polyolefin laminate of claim [c1] wherein the flexible polyolefin woven substrate comprises double stacked weave of polyolefin tapes.

7. The breathable polyolefin laminate of claim [c1] wherein the tie layer bonding material comprises polyolefin and from 1% to 5% weight foaming agent.

8. The breathable polyolefin laminate of claim [c7] wherein the foaming agent is selected from the group consisting of citric acid and azodicarbonimide.

9. The breathable polyolefin laminate of claim [c1] wherein the tie layer bonding material comprises low density polyethylene and from 1% to 30% weight incompatible polymer.

10. The breathable polyolefin laminate of claim [c9] wherein the incompatible polymer is selected from the group consisting of polyamide, polyester, polystyrene, polycarbonate, and polyvinyl chloride.

11. The method of producing the breathable polyolefin laminate of claim [c1] comprising the steps of:
extrusion coating the tie layer bonding material to an upper surface of the flexible polyolefin woven substrate to form a coated flexible woven substrate;
cooling the coated flexible woven substrate to a temperature 10 degrees Fahrenheit below the melt temperature of the tie layer bonding material; and
compressing the breathable polyolefin film against the upper surface of the coated flexible woven substrate.

12. A breathable polyolefin laminate comprising:
(i) a breathable polyolefin film;
(ii) a tie layer bonding material; and
(ii) a flexible polyolefin woven substrate;
wherein the breathable polyolefin film comprises porous channels that permit high moisture vapor transmission with low air penetration and with high water penetration resistance;
wherein the tie layer bonding material adheres the breathable polyolefin film to the flexible polyolefin woven substrate;
wherein the tie layer bonding material comprises non-breathable polyolefin and from 1% to 5% weight foaming agent applied in a porous web; and
wherein the breathable polyolefin laminate provides high moisture vapor transmission with low air penetration and with high water penetration resistance without needle punching of the laminate.

13. The breathable polyolefin laminate of claim [c12] wherein the breathable polyolefin film comprises apertured polyolefin film.

14. The breathable polyolefin laminate of claim [c12] wherein the breathable polyolefin film further comprises ultraviolet light inhibitors.

15. The breathable polyolefin laminate of claim [c12] wherein the tie layer bonding material comprises low density polyethylene and from 1% to 5% weight of a foaming agent selected from the group consisting of citric acid and azodicarbonimide.

16. The breathable polyolefin laminate of claim [c12] wherein the flexible polyolefin woven substrate comprises double stacked weave of polyolefin tapes.

17. A breathable polyolefin laminate comprising:
(i) a breathable polyolefin film;
(ii) a tie layer bonding material; and
(ii) a flexible polyolefin woven substrate;
wherein the breathable polyolefin film comprises porous channels that permit high moisture vapor transmission with low air penetration and with high water penetration resistance;
wherein the tie layer bonding material adheres the breathable polyolefin film to the flexible polyolefin woven substrate;
wherein the tie layer bonding material comprises non-breathable polyolefin and from 1% to 30% weight incompatible polymer applied in a porous web; and
wherein the breathable polyolefin laminate provides high moisture vapor transmission with low air penetration and with high water penetration resistance without needle punching of the laminate.

18. The breathable polyolefin laminate of claim [c17] wherein the breathable polyolefin film comprises apertured polyolefin film.

19. The breathable polyolefin laminate of claim [c17] wherein the breathable polyolefin film further comprises ultraviolet light inhibitors.

20. The breathable polyolefin laminate of claim [c17] wherein the tie layer bonding material comprises low density polyethylene and from 1% to 30% weight of an incompatible polymer selected from the group consisting of polyamide, polyester, polystyrene, polycarbonate and polyvinyl chloride.

21. The breathable polyolefin laminate of claim [c17] wherein the flexible polyolefin woven substrate comprises double stacked weave of polyolefin tapes.
